(19) United States
(12) Patent Application Publication
(10) Pub. No.: US 2016/0146196 A1
(43) Pub. Date: May 26, 2016

(54) ROTARY PRESSURE RELIEF SYSTEM AND METHOD

(71) Applicant: EXERGYN LTD., Dublin (IE)

(72) Inventors: Georgiana Tirca-Dragomirescu, Dublin (IE); Ronan Byrne, Dublin (IE); Rory Beirne, Dublin (IE)

(21) Appl. No.: 14/898,156

(22) PCT Filed: Jun. 13, 2014
(86) PCT No.: PCT/EP2014/062395

§ 371 Date: Dec. 14, 2015

(30) Foreign Application Priority Data
Jun. 13, 2013 (GB) 1310531.7

(51) Int. Cl. F03G 7/06

(52) U.S. Cl. CPC F03G 7/065

(57) ABSTRACT

The invention provides an energy recovery device comprising a first SMA core housed in a first immersion chamber and adapted to be sequentially filled with fluid to allow heating and/or cooling of the first SMA core wherein a first shaft is adapted to be turned by the SMA core mounted concentrically around said first shaft; a second SMA core housed in a second immersion chamber and adapted to be sequentially filled with fluid to allow heating and/or cooling of the second SMA core wherein a second shaft is adapted to be turned by the second SMA core mounted concentrically around said second shaft; wherein the first and second core are in fluid communication with each other.

### FIELD

The present application relates to the field of energy recovery and in particular to the use of shape memory alloys (SMA) for same.

### BACKGROUND

Low grade heat, which is typically considered less than 100 degrees, represents a significant waste energy stream in industrial processes, power generation and transport applications. Recovery and re-use of such waste streams is desirable. An example of a technology which has been proposed for this purpose is a Thermoelectric Generator (TEG). Unfortunately, TEG's are relatively expensive. Another largely experimental approach that has been proposed to recover such energy is the use of Shape Memory Alloys.

A shape-memory alloy (SMA) is an alloy that “remembers” its original, cold-forged shape which once deformed returns to its pre-deformed shape upon heating. This material is a lightweight, solid-state alternative to conventional actuators such as hydraulic, pneumatic, and motor-based systems.

The three main types of shape-memory alloys are the copper-zinc-aluminium-nickel, copper-aluminium-nickel, and nickel-titanium (NiTi) alloys but SMAs can also be created, for example, by alloying zinc, copper, gold and iron.

The memory of such materials has been employed or proposed since the early 1970's for use in heat recovery processes and in particular by constructing SMA engines which recover energy from heat as motion.

In a first type, referred to as a crank engine, of which U.S. Pat. No. 468,372 is an example, convert the reciprocating linear motion of an SMA actuator into continuous rotary motion, by eccentrically connecting the actuator to the output shaft. The actuators are often trained to form extension springs. Some configurations require a flywheel to drive the crank through the mechanism's limit positions. A related type are Swash Plate Engines, which are similar to cranks except that their axis of rotation is roughly parallel to the direction of the applied force, instead of perpendicular as for cranks.

A second type are referred to as a pulley engines, an example of which is U.S. Pat. No. 4,010,612. In pulley engines, continuous belts of SMA wire is used as the driving mechanism. A pulley engine may be unsynchronized or synchronized. In unsynchronized engines, the pulleys are free to rotate independently of one another. The only link between different elements is rolling contact with the wire loops. In contrast, in synchronized engines, the pulleys are constrained such that they rotate in a fixed relationship. Synchronization is commonly used to ensure that two shafts turn at the same speed or keep the same relative orientation.

A third type of SMA engine may be referred to as field engines, an example of which is U.S. Pat. No. 4,027,479. In this category, the engines work against a force, such as a gravitational or magnetic field.

A fourth type of SMA engine is that of Reciprocating Engines of which U.S. Pat. No. 4,434,618 in an example. These reciprocating engines operate linearly, in a back-and-forth fashion, as opposed to cyclically.

A fifth type of SMA engine is that of Sequential Engines of which U.S. Pat. No. 4,938,026 is an example. Sequential engines move with small, powerful steps, which sum to substantial displacements. They work like an inchworm, extending the front part by a small step and then pulling the back part along. With the back part nearby, the front part can extend again.

A sixth type of SMA engine is shown in U.S. Pat. No. 5,150,770A, assigned to Contraves Italiana S.p.A., and discloses a spring operated recharge device. There are two problems with the Contraves device, namely it is difficult to recharge quickly in a reciprocating manner and secondly it is difficult to discharge the energy to a transmission system without losses occuring.

A seventh type of SMA engine is shown in US patent publication number US2007/261307A1, assigned to Breezway Australia Pty Limited, and discloses an energy recovery charge system for automated window system. Breezway discloses a SMA wire that is coupled to a piston which is used to pump fluid to a pressurised accumulator. The piston therefore moves in tandem with the SMA wire as it contracts and expands. By coupling the SMA wire to the piston in this manner, the SMA wire is in indirect communication with the energy accumulator via the pumped fluid which is ineffiecient and the Breezway system suffers from the same problems as Contraves.

In addition one of the difficulties with each of these types of SMA engines has been that of the cycle period of the SMA material. SMA material is generally relatively slow to expand and contract (10's of RPM). It has been and remains difficult to achieve a worthwhile reciprocating frequency that might be usefully employed in an industrial application (100's to 1000's of RPM). This is not a trivial task and generally is complicated and involves significant parasitic power losses.

Another problem in a drive incorporating a SMS engine is pressure fluctuation due to the contraction of Shape Memory Alloy (SMA) components contained within the power producing cores of the drive. This uniform contraction of the SMA components is caused by Bain strain, and results in a volumetric increase within the cores during the heating phase of the SMA. This volumetric change occurs in a system with an incompressible fluid present, and hence, may cause significant pressure variation which may result in system failure. Other patent publications in the art include U.S. Pat. No. 4,037,411 and U.S. Pat. No. 4,030,298.

The present application is directed to solving at least one of the above mentioned problems.

### SUMMARY

According to the invention there is provided, as set out in the appended claims, an energy recovery device comprising:
a first SMA core housed in a first immersion chamber and adapted to be sequentially filled with fluid to allow heating and/or cooling of the first SMA core wherein a first shaft is adapted to be turned by the SMA core mounted concentrically around said first shaft.

In one embodiment there is provided an energy recovery device comprising:
a first SMA core housed in a first immersion chamber and adapted to be sequentially filled with fluid to allow heating and/or cooling of the first SMA core wherein a first shaft is adapted to be turned by the SMA core mounted concentrically around said first shaft;
a second SMA core housed in a second immersion chamber and adapted to be sequentially filled with fluid to allow heating and/or cooling of the second SMA core wherein a second shaft is adapted to be turned by the second SMA core mounted concentrically around said second shaft;
wherein the first and second core are in fluid communication with each other.

In one embodiment the invention links two cores volumetrically, and by operating them in opposing heating cooling cycles will allow for these volumetric fluctuations to cancel each other out.

The invention solves the problem of pressure fluctuation occurring in a drive caused by volumetric contraction and expansion of SMA wire contained within a closed immersed chamber. The invention disclosed offers a simple effective method of removing this issue with minimal additional components. The shrinking of the SMA wires causes a pressure drop in this instance, the pressure relief systems hereinbefore described therefore act in the opposite way to those for the linear systems.

In one embodiment the first and second cores are in fluid communication via an adjoining piston or hydraulic line.

In one embodiment a constant volume in each core is maintained through a piston connection between the first and second cores.

In one embodiment the first or second SMA core is linked with a moveable piston in the chamber; wherein the piston is configured with a shaft that has a substantially same Cross Sectional Area (CSA) that will displace the same combined volume of the linear and/or radial contractions of the SMA core over the length of one expansion or contraction.

In one embodiment the first or second SMA core is linked with a moveable first piston in the chamber; a second piston adapted to operate in a non-synchronous manner with the first piston.

In one embodiment the first or second immersion chamber is configured with an additional chamber comprising a biasing means, such as a spring, wherein on the SMA core expanding in said chamber the biasing means allows fluid to flow into the additional chamber.

In another embodiment there is provided an energy recovery device comprising:
a first SMA core housed in a first immersion chamber and adapted to be sequentially filled with fluid to allow heating and/or cooling of the first SMA core wherein a first shaft is adapted to be turned by the SMA core mounted concentrically around said first shaft; and
the immersion chamber is configured with an additional chamber comprising a biasing means, such as a spring, wherein on the SMA core expanding in said chamber the biasing means allows fluid to flow into the additional chamber.

In a further embodiment there is provided an energy recovery device comprising:
a first NTE material core housed in a first immersion chamber and adapted to be sequentially filled with fluid to allow heating and/or cooling of the first NTE material core wherein a first shaft is adapted to be turned by the NTE material core mounted concentrically around said first shaft;
a second NTE material core housed in a second immersion chamber and adapted to be sequentially filled with fluid to allow heating and/or cooling of the second NTE material core wherein a second shaft is adapted to be turned by the second NTE material core mounted concentrically around said second shaft;
wherein the first and second core are in fluid communication with each other.

The invention provides a number of mechanical embodiments that remove issues associated with attempting to solve the pressure pulsing issue using hydraulic linkages through the working fluid. These methods will share the pressure pulse with other pressure vessels in the system, which are not capable of withstanding rapid pressure variations. A mechanical linkage method does not incorporate these issues, as it will maintain a constant volume at all times.

The invention provides a mechanical volume exchange embodiment that reduces the required inventory when compared with pressure relief methods whereby each individual core contains a mechanism which allows for pressure regulation independent of other cores in the system. Therefore, this represents an advantage for the mechanical volumetric exchange concept over these approaches, as it will require one pressure relief mechanism for every two cores in the system. This concept will also partition the fluid within coupled cores, preventing mixing of hot and cold fluid flows. This offers an advantage over other methods which require an exchange of fluid to take place, as the mixing of fluid with different temperatures may have a negative effect on the operation of the SMA components contained within cores. An example of this may be a cold flow entering a heating core, where this cold flow would reduce the temperature in the core and thereby increase the time required to fully contract the SMA wire contained within said core.

In one embodiment there is provided a plurality of rotary stacked cores on a shaft where the net effect is a total accumulated movement of the shaft without the cumulative movement of the stacked cores themselves. This is made possible by the use of the over-running clutches at the centre of the core.

### BRIEF DESCRIPTION OF THE DRAWINGS

The invention will be more clearly understood from the following description of an embodiment thereof, given by way of example only, with reference to the accompanying drawings, in which:—

FIG. 1 illustrates a Rotary Core Arrangement;

FIG. 2 illustrates a single module operation during its (a) cooling, and (b) heating cycles;

FIG. 3 illustrates example Martensite & austensite wire dimensions;

FIG. 4 illustrates volume exchange pressure relief operation, (a) As core A cools, it passes its displaced volume onto core B, and (b) as core B cools, it passes its displaced volume onto core A;

FIG. 5 illustrates SMA wire contractions;

FIG. 6 illustrates Hydraulic Piston dimensions according to one embodiment;

FIG. 7 illustrates operation of fluid exchange pressure relief according to one embodiment;

FIG. 8 illustrates operation of spring resisted pressure relief mechanism during (a) cooling, and (b) heating;

FIG. 9 illustrates operation of power producing hydraulic element during (a) cooling, and (b) heating (transmission embodiment not shown);

FIG. 10 illustrates operation of a threaded piston embodiment during (a) cooling, and (b) heating of core;

FIG. 11 illustrates pressure relief freedom of movement according to one embodiment;

FIG. 12 is a 3D illustration of a threaded piston embodiment (left) and location of notch and boss features (right);

FIG. 13 illustrates a pressure relief sleeve embodiment during (a) cooling, and (b) heating of the core;

FIG. 14 illustrates a gear operated threaded pressure relief piston during (a) cooling, and (b) heating of the core;

FIG. 15 illustrates a pressure relief piston implementing bevel gears operation during (a) cooling, and (b) heating of the core;

FIG. 16 illustrates operation of mechanically linked volume exchange pressure relief, (a) After core A has cooled and prepared to begin heating, (b) as core A heats, it accepts excess volume from core B, which is cooling; and

FIG. 17 illustrates volumetric displacements that can occur in device operation during (a) cooling, and (b) heating of core A, while the opposite displacements simultaneously occur in core B.

### DETAILED DESCRIPTION OF THE DRAWINGS

It will be appreciated that while SMA material/core is substantially described herein with respect to the Figures, the invention can be applied to a class of materials more generally known as ‘active material’ or Negative Thermal Expansion (NTE) materials. NTE materials include those compositions that can exhibit a change in stiffness properties, shape and/or dimensions in response to an activation signal, which can be an electrical, magnetic, thermal or a like field depending on the different types of active materials. Preferred active materials include but are not limited to the class of shape memory materials, and combinations thereof. Shape memory materials, a class of active or NTE materials, also sometimes referred to as smart materials, refer to materials or compositions that have the ability to remember their original shape, which can subsequently be recalled by applying an external stimulus (i.e., an activation signal).

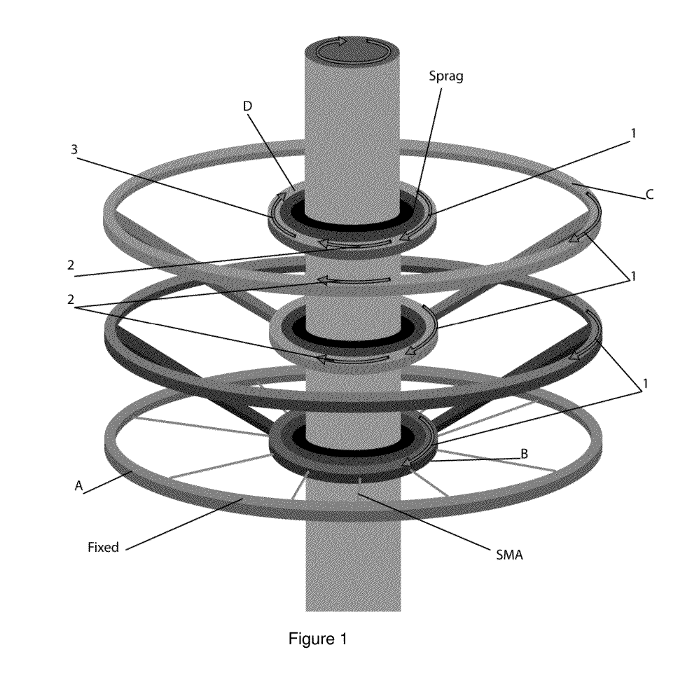

An embodiment of the power producing cores is a rotary arrangement, as shown in FIG. 1. This core produces work in the form of a rotating shaft, which is directly turned by SMA components mounted concentrically around said shaft. The core creates a usable rotation through the use of modules of rotary producing SMA mechanisms, which utilise an accumulative effect, which results in a large rotation relative to that created by each individual module. After each rotation caused by the SMA contraction, or power turn, the shaft is rotated back to its original position through relaxation forces during the core cooling cycle. The arrangement of this concept is illustrated in FIG. 1.

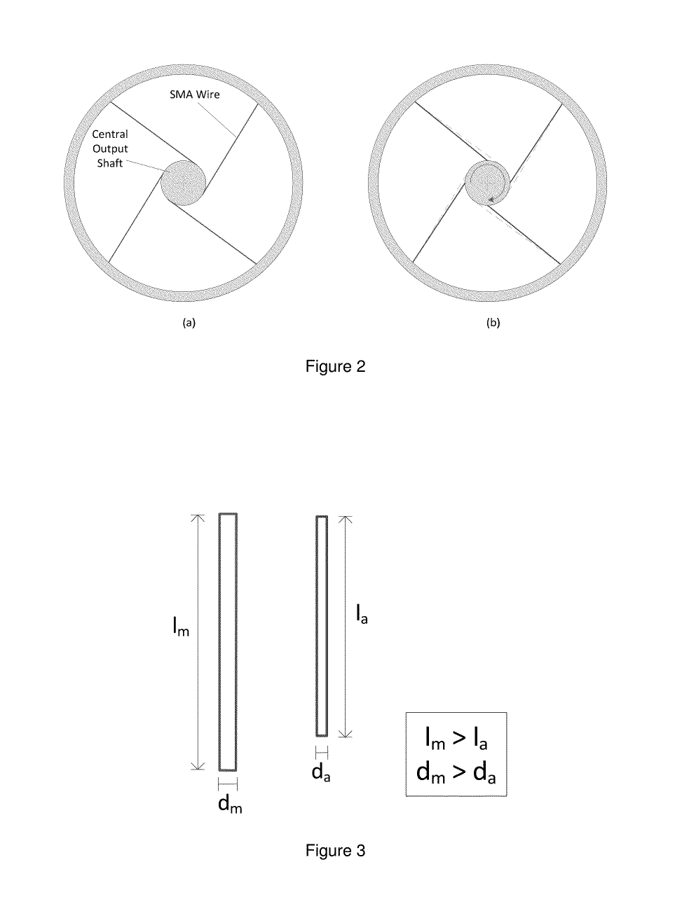

The operation of a single module as it transitions from a cold state to a heated state is illustrated. This process results in the SMA wire undergoing a phase change from martensite to austenite. This change results in the wire contracting uniformly due to Bain strain as it rotates the central shaft. As mentioned previously, this contraction alters the volume of the core. The operation of a single module of the rotary core is shown in FIG. 2.

It can be seen from FIG. 2 that as the SMA contracts, its length decreases. In addition to this linear reduction, the wire also undergoes a radial reduction. This is illustrated in FIG. 3 below, where the martensitic (cooled) SMA wire (blue) is shown to have a greater length, lₘ, and diameter, dₘ, than the austenitic wire (red).

It can be concluded from FIGS. 2 and 3 that the contraction of the SMA wires represents an increase in volume within their respective cores, and hence will cause a pressure drop within the system. This is due to the inverse relationship between volume and pressure (P∝1/V). This pressure drop problem can be solved using a number of embodiments.

### Hydraulic Methods

Hydraulic methods of pressure relief rely on the working fluid within the system to operate mechanisms which alter the volume of the system in order to counter act the volume changes caused by the SMA. There are multiple arrangements which this aspect of the invention maybe embodied, which are now described:

### Hydraulic Volume Exchange

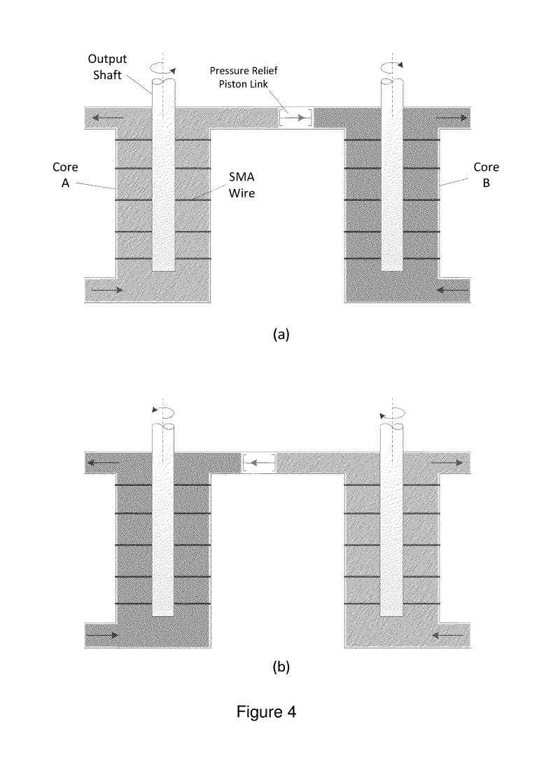

It has been concluded above that the volume of each core will increase during heating, and decrease during cooling. In one embodiment the invention links two cores volumetrically, and by operating them in opposing heating cooling cycles will allow for these volumetric fluctuations to cancel each other out. This link allows for the excess volume created by a cooling core to be “passed on” to a heating core in order to cancel out the volumetric change caused by the contracting wire located in the heating core. This operation is illustrated in FIG. 4.

The method illustrated in FIG. 4 allows for a constant volume to be present in both cores at all times of their operation. This method can be expanded to allow for multiples of two cores linked as shown, as well as other embodiments of the system which may have disparate heating and cooling times.

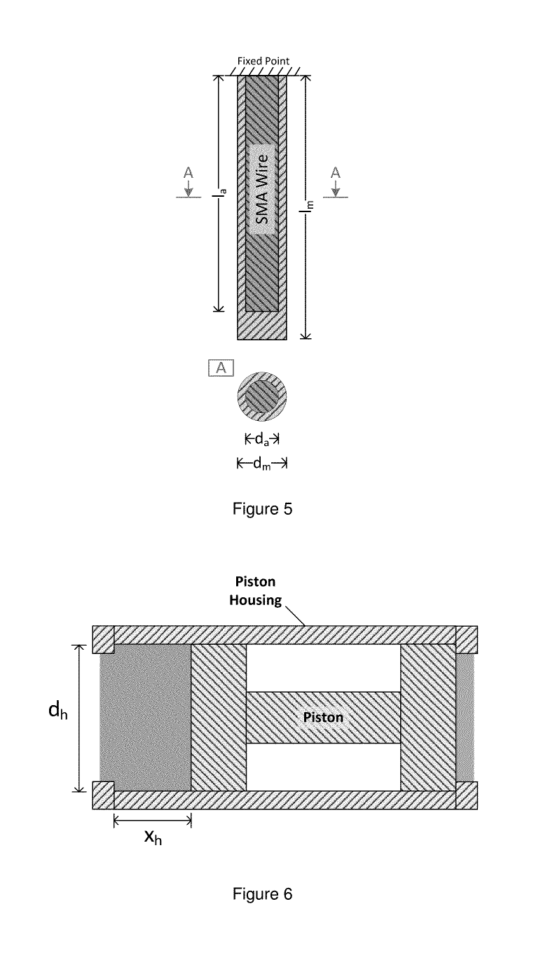

In order to appropriately size a Pressure Relief Piston (PRP) for this application, the volumetric displacements caused by the SMA components must first be identified. The contraction undergone by the SMA wire is caused by Bain strain. This results in the wire contracting in all directions. In the case of a wire the contractions occur linearly and radially. This is shown in FIG. 5, where the wire length reduces from lₘ to lₐ, and the diameter reduces from dₘ to dₐ.

In order to determine the correct diameter of the piston shaft, the following procedure should be followed:
1. Determine the volumetric change caused by the linear contraction of the SMA.
   a. Define the initial Cross Sectional Area (CSA), A₁, of each individual wire;

$${A}_{1} = \frac{π {d}_{m}^{2}}{4}$$

Where dₘ=Diameter of wire before contraction.
   b. Calculate the volume displaced by linear contraction, V₁;

V₁=A₁(lₘ−lₐ)
Where lₘ=Length of SMA wire before contraction, and lₐ=Length of SMA wire after contraction.
2. Determine the volume displaced by radial contraction.
   a. Find the CSA of the radial contraction, A₂, which is seen to be the difference in the CSA's of the wire initially and after contraction;

$${A}_{2} = \frac{π {d}_{m}^{2}}{4} - \frac{π {d}_{a}^{2}}{4} = \frac{π {d}_{m}^{2} - π {d}_{a}^{2}}{4}$$

Where dₐ=Diameter after contraction.
   b. Calculate the volume displaced by radial contraction, V₂;

V₂=A₂lₐ
3. Determine the total volumetric reduction of the SMA wires, V_{SMA}.

V_{SMA}=(V₁+V₂)N
Where N=Number of SMA wires located in the core.

The total volume displaced by the SMA wires can now be implemented to assist in specifying an appropriate PRP link. The main factors which must be considered for designing the PRP head are the Cross Sectional Area (CSA) of the head, and the required level of deflection. Both of these factors will be functions of the displaced volume of the SMA components within the core. FIG. 6 illustrates these dimensions.

Using the equation for volume of a cylinder, the dimensions of the pressure relief piston head can be calculated, provided either the allowable deflection or piston face diameter of the component is known. This methodology can be applied to designing a piston head for use with the hydraulic line of a motorbike master cylinder, for example. In such a device there is an allowable movement of roughly 10mm. Assuming the required volume to be displaced has already been calculated, and an allowable deflection is imposed, the following procedure can be followed to determine an appropriate piston face diameter, where Aₕ is the CSA of the PRP face.

$${V}_{SMA} = {A}_{h} {x}_{h}$$

$${A}_{h} = \frac{{V}_{SMA}}{{x}_{h}}$$

$$\frac{π {d}_{h}^{2}}{4} = \frac{{V}_{SMA}}{{x}_{h}}$$

$${d}_{h} = \sqrt{\frac{4 {V}_{SMA}}{π {x}_{h}}}$$

The above procedure may be manipulated to determine the required allowable deflection for a specified face diameter. An example of when this may be appropriate could be designing the device for use with standard piston parts.

### Fluid Exchange

Another method of hydraulic pressure relief is through fluid exchange, where the displaced volumes of fluid are passed between cores thereby eliminating the pressure pulse. The volume exchange would be achieved through a direct link to each core, where fluid will be free to flow. This will lead to pressure being relieved, as excess volume from a cooling core can be passed on to a heating core, compensating for this increase in volume. The connection can be attached at the core outlets to the next cores inlet. This results in excess volume being forced though the outlet, and volume being added to the inlet. This is preferable as the volume displacements will be in line with the flow of the working fluid.

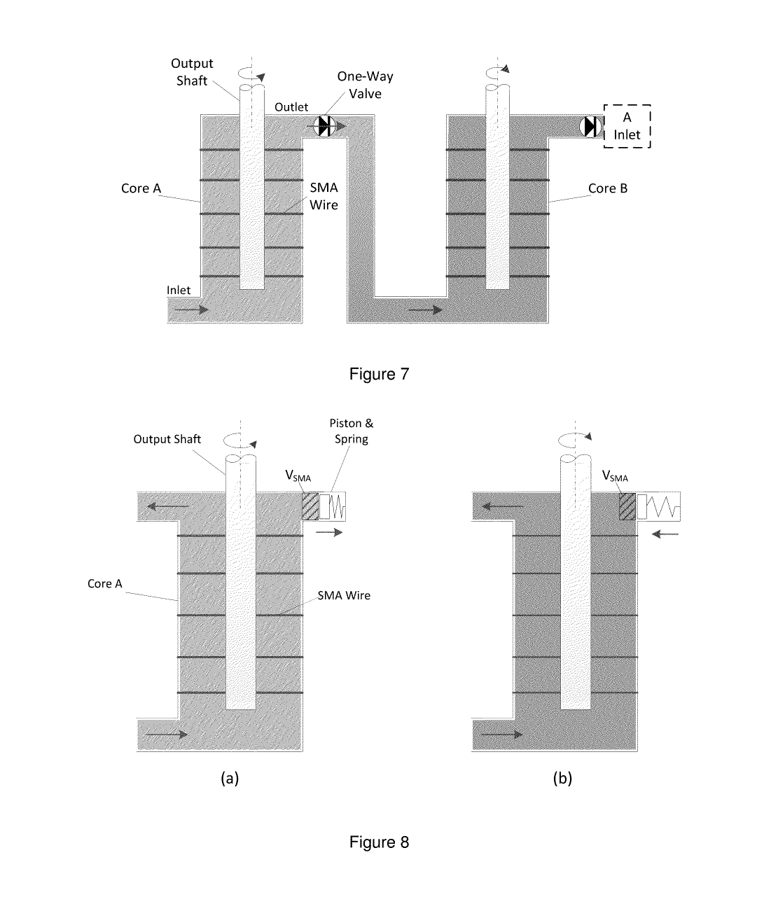

In the most basic embodiment of the invention a drive comprising two SMA cores are provided, heating and cooling in opposing sequences. FIG. 7 illustrates this system with the pressure relief components attached. It can be seen from this figure that as core A cools, the excess fluid is passed through a one-way valve to the heating core B. This valve will allow fluid to flow through it when pressure increases beyond the system operational pressure. This will relieve the pressure increase caused by the expanding SMA by using the heating core as a faux expansion vessel, and vice versa. This results in constant volumes being present in the cores, and hence no pressure fluctuations.

It may be said that the exchange of fluid between two cores as shown in FIG. 7 above may incur negative effects, by flowing cold water into an actively heating core. This may result in increasing the time required to heat said core. Therefore measurements should be taken to ensure this does not occur. Solutions to this are:
The use of an idle or buffer core which can be located between actively heating and cooling cores. This core can be held idle in a heated state, which would allow cool fluid from a cooling core to enter it while passing on heated fluid to a heating core. As the idle core will be fully heated, it will not be capable of accepting any additional mass, and hence, passes it on. This arrangement will allow for the fluid exchange between active cores, without adversely affecting their operational conditions. In addition to this, the use of the idle core facilitates a pre-cooling effect on itself. This would occur as a result of the introduction of the cool fluid from the cooling core. This will reduce the temperature of the idle core, and reduce the time of its cooling cycle.
The implementation of regenerative heat exchanger (regenerator) between the cores. This regenerator can be placed in the line travelling from the core outlet to outlet. The use of a regenerator would remove the need for two connecting lines between the cores as shown in FIG. 7. The regenerator can be used to store and release heat from and to the fluid being exchanged between the cores. This will reduce or remove the adverse effects of the exchange of different temperature fluids between cores.

The one-way valves used in the mechanism can be pressure sensitive, in that they must act as a closed valve at normal operating pressure, but then act as an open one-way valve when this pressure increases due to the expanding SMA. Therefore, it may be required to define the pressure pulse in order to spec this valve. The pulse can be determined using the bulk modulus formula. The bulk modulus can be used as a method of measuring the amount of compression a material will undergo under a given pressure.

The bulk modulus, B, is defined by the following equation;

$$B = \frac{Δ P}{\frac{Δ V}{V}} = \frac{Δ P \cdot V}{Δ V}$$

Where P is pressure in Pascals (Pa), and V is volume in m³.

Therefore, the change in pressure or pressure pulse can be found by supplying the above equation with the initial volume of the system, the change in volume, and the bulk modulus of the fluid contained therein.

$$Δ P = \frac{B \cdot Δ V}{V}$$

The drive may use various different fluids for different applications, and hence the bulk modulus of these various fluids would need to be identified. For example in some embodiments this fluid may be water, whose bulk modulus is 2.2×10⁹ N/m². The initial volume of the system can be found by determining the total volume contained within all cores, all piping used, reservoirs etc. Finally, the change in volume can be found by determining the volumetric displacement caused by the SMA, as discussed above. Once the value for the pressure drop is determined, an appropriately sensitive valve can be specified.

### Core Housing

Appropriate alterations to the power producing cores can allow for mass to be moved about said core in such a way which would facilitate a decrease in the volume of the core, which can offset the variation caused by the contracting SMA. This may be applied to various configurations of the Drive.

The use of compression spring resisted pistons within the Piston Housing (PH) provides a solution to the pressure variation issue. These pistons allow for volumetric increases and decreases when needed within the core in order to counteract the volume changes caused by the expanding and contracting SMA wire, as illustrated in FIG. 8.

As can be seen in FIG. 8, as the core cools the pressure relief pistons accepts the displaced volume of the expanding SMA wires and maintains a constant volume in the core. Similarly, as the core heats and the SMA contracts, the spring resisted pistons returns to a less compressed state, reducing the volume of the core by the same amount as the increase caused by the SMA. This is achieved by allowing the initial system pressure to compress the spring during the cold cycle. When the core is heated the pressure drop associated with the SMA contraction will allow for the piston to decompress by an amount proportional to the magnitude of said pressure drop. In order for the mechanism to operate correctly, the distance through which the spring piston traverses during this decompression must displace a volume equal to that caused by the SMA contraction. This is also shown in FIG. 8 above, where this volume is denoted as V_{SMA}. A method of determining an appropriate spring for this application is outlined below, where the piston head diameter, volume reduction caused by SMA contraction, initial pressure, and pressure drop are known values.

### Example Spring Calculation

Using Hooke's Law, it is possible to define the required spring constant (k) which would be used to determine a spring which would allow the required deflections which it must undergo. Hooke's Law can be expressed via the equation;

F=−kx

Where F is the force applied to the spring, and x is the resulting deflection of the spring.

Since the primary function of the spring will be to displace a specific volume based on its piston face surface area, it is necessary to determine the correct value for the spring constant (k) based on the piston's required displacement. This can be achieved as follows.
1. Determine the force acting on the piston face at the nominal system pressure and at the pressure drop.
   a. Determine the force, Fᵢ, acting on the piston face area, A, initially, caused by system pressure, Pᵢ;

$${P}_{i} = \frac{{F}_{i}}{A}$$

$${F}_{i} = {P}_{i} A$$

b. Determine the force, F_{f}, acting on the piston after the pressure drop occurs, P_{f};

$${P}_{f} = \frac{{F}_{f}}{A}$$

$${F}_{f} = {P}_{f} A$$

2. Determine the required deflection, x_{d}, of the spring piston which will cancel out the volume increase caused by the SMA contraction where d is the piston head diameter.

$${V}_{SMA} = {Ax}_{d}$$

$${x}_{d} = \frac{4 {V}_{SMA }}{π {d}^{2}}$$

3. Using the values for F_{f} and Fᵢ, use simultaneous equations to determine the required spring stiffness, k, based on Hooke's law;

Fᵢ=−kxᵢ [1]

F_{f}=−kx_{f} [2]
a. Equation 1 can be reduced to;

$$- k = \frac{{F}_{i}}{{x}_{i}}$$

b. Equation 2 can be expressed as follows, where the final deflection, x_{f}, can be expresses as the difference of the initial deflection and deflection required, x_{d}, to eliminate the pressure drop;

F_{f}=−k(xᵢ−x_{d})
4. The expression fork in equation 1 can be subbed into equation 2 in order to determine the initial displacement of the spring, xᵢ. After performing this, equation 2 can be reduced to;

$${x}_{i} = \frac{{F}_{i} {x}_{d}}{{F}_{i} - {F}_{f}}$$

5. Using the value for the initial deflection, the required spring constant can be found by subbing back in to equation 1.
6. The required spring can now be designed to the spring constant by examining available springs on the market, and determining appropriate spring dimensions for this application giving considerations to the overall required deflection of the spring.

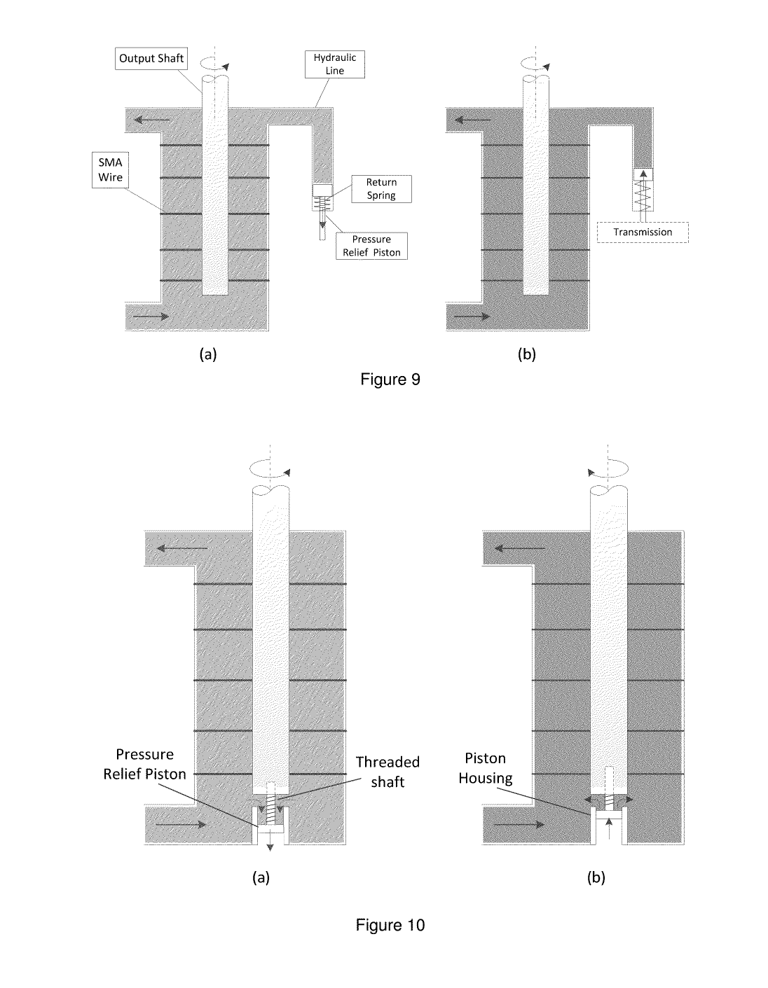

Another arrangement which this embodiment can take is one in which power is drawn from the pressure variations. This can be achieved by mating a hydraulic line with a transmission, which can be used for various applications, including contributing to the power output of the system, or operating a valve train. The arrangement consists of a piston, a return spring, and a transmission, as illustrated in FIG. 9.

As can be seen from FIG. 9, as the core cools and the SMA expands, the force created pushes the hydraulic piston downwards, and thereby increasing the volume of the system by the appropriate amount. It is during this cycle that the pressure relief piston performs its power stroke whereby it transmits work to the transmission. This operation will also lead to constant volume present in the core, and hence no pressure variations. As the core heats, the opposite operation occurs, where the SMA contracts, and the hydraulic pressure relief piston rises due to the presence of the return spring, once again maintaining a constant pressure. It should be noted that this stroke does not perform any work on the transmission, and is merely purposed to return the piston back to its original location. Hence, the PRP will do work only during the cooling cycle.

### Mechanical Methods

Mechanical methods of pressure relief that rely on means which are isolated from the working fluid to alter the volume of the system in order to counter act the volume changes caused by the SMA. There are multiple arrangements which this concept may appear. These are discussed as follows.

### Threaded Piston

In one embodiment the device uses a piston with a threaded shaft to offer a mechanism for pressure relief. The piston can be coupled with the output shaft located in the centre of the core, and would convert the rotary movement of this shaft into linear, in order to regulate the volume. The operation of such a device is shown in FIG. 10.

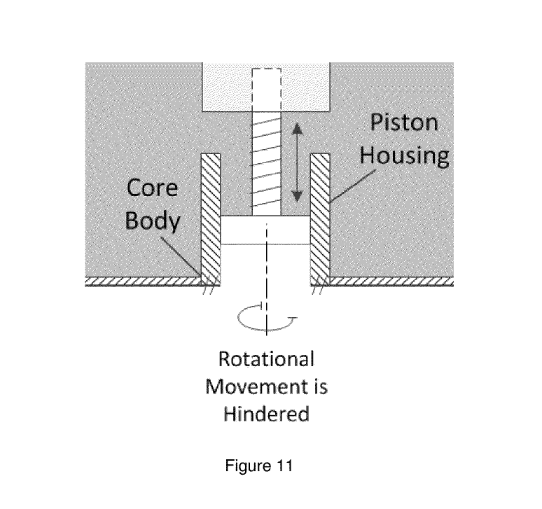

It can be seen from FIG. 10(a) that as the core cools and the SMA expands, the PRP lowers as a result of the counter clockwise rotation of the output shaft. This results in an increase in volume of the core, and thereby cancelling out the decrease caused by the expansion of the SMA wires. FIG. 10(b) shows the operation of the core during its heating cycle, where the PRP ascends due to the clockwise rotation of the output shaft. This rising piston reduces the volume contained within the core by the same amount as is added by the contraction of the SMA wires. It can also be seen that there is a requirement for a piston housing which is fixed to the core body so as to remain stationary. This is due to the fact that in order for the piston to move linearly as a result of the output shafts rotation, it must be unable to rotate itself. The pistons allowable movement is illustrated in FIG. 11.

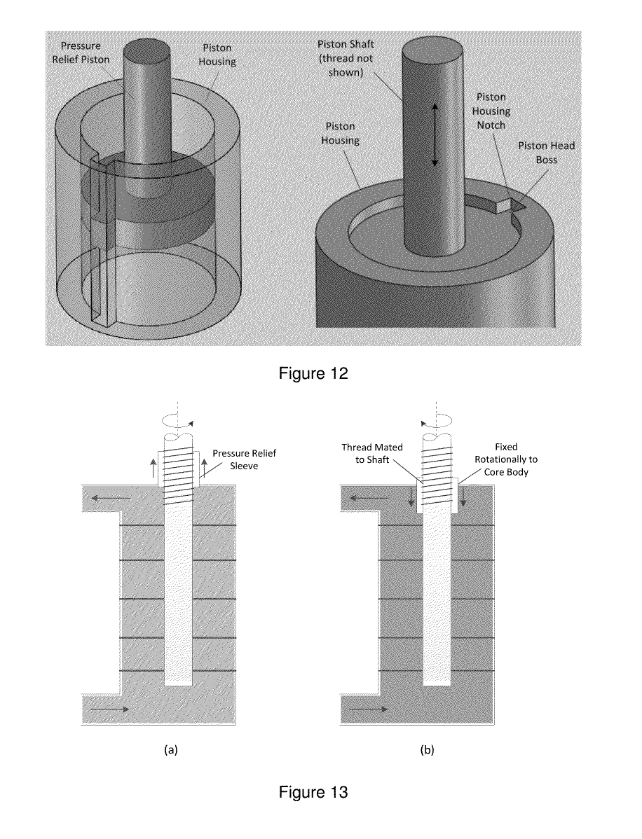

Multiple methods of preventing the piston from rotating within its housing may be employed. One such method could be to manufacture a notch into the housing which would be used as a rail for sliding the piston linearly, while preventing its rotation. This would be achieved by including a boss on the piston head which would correspond to the notch in the housing. A 3D mock-up of this mechanism is shown in FIG. 12.

In order for this pressure relief mechanism to operate correctly, it should displace an equal volume to that caused by the SMA contraction. Therefore a method of determining an appropriate piston size must be devised. It can be said that if the PRP displaces a volume equal to V_{SMA} during its upstroke (during core heating), then it will cancel out the volume increase caused by the SMA contraction. Assuming the allowable distance which the piston can travel due to geometrical constraints within the core is known as well as the volume associated with the SMA contraction, a suitable piston size can be found, by following the procedure outlined below.
1. Determine the required face surface area of the PRP (A_{P}) to displace the correct volume, where x_{M} is the allowable stroke, neglecting the area associated with the notch;

$${A}_{P} {x}_{M} = {V}_{SMA}$$

$${A}_{P} = \frac{{V}_{SMA}}{{x}_{M}}$$

2. Determine the required PRP diameter to displace the appropriate volume, while accounting for the fact that the piston rod which travels the length of the piston head housing will not contribute to any volumetric displacements, and hence must be considered in the PRP design. The PRP head must be sized to have a total surface area (A_{T}) which will displace the desired volume in addition to the CSA of the piston rod (AR);

$${A}_{T} = {A}_{P} + {A}_{R}$$

$$\frac{π {d}_{T}^{2}}{4} = \frac{{V}_{M}}{{x}_{P}} + \frac{π {d}_{R}^{2}}{4}$$

$${d}_{T} = \sqrt{\frac{4 {V}_{M}}{π {x}_{p}} + {d}_{R}}$$

where d_{R} is the diameter of the piston rod.

Therefore it can be said that, using the above procedure, it is possible to specify an appropriately sized PRP head based on the geometries of the core.

In addition to the considerations given above when defining an appropriate piston size, attention must be given to the suitability of the thread located on the piston shaft. This thread should be capable of producing the desired linear displacement to the piston for a set rotation. This property is dependent upon the geometries of the screw. Such geometries are the distance between threads along the screw (pitch), and the linear distance along the screw which it will travel in one revolution (lead). The lead can be increased by either increasing the pitch or using additional starts (more individual ridges).

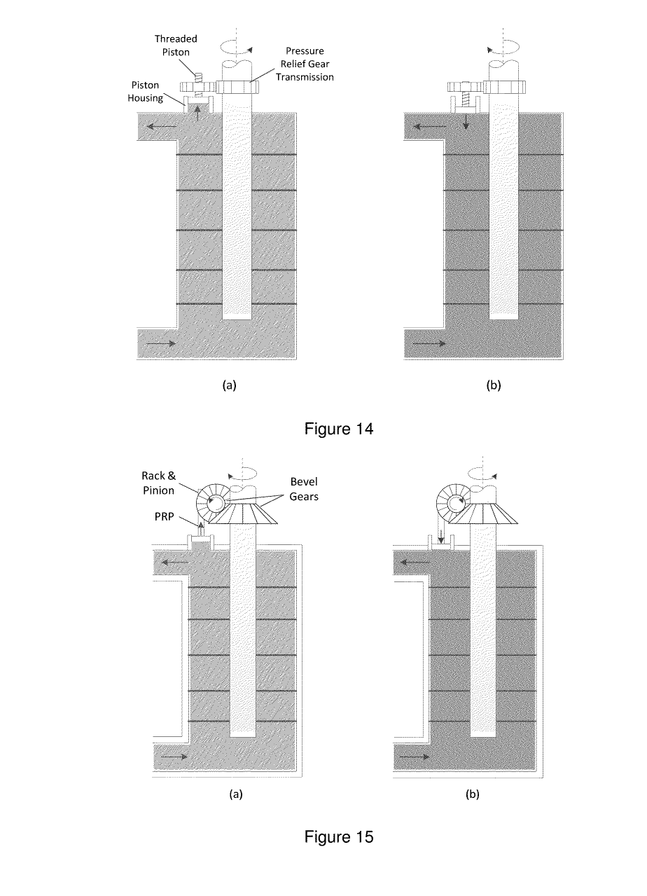

FIG. 13 illustrates a embodiment which uses the same operating principals as the piston concept where the piston is replaced with a sleeve. The sleeve can be located at the entry point of the shaft to the core and mounted concentrically with respect to said shaft. This concept would remove any concerns about available space at the bottom of the interior of the core. The sleeve can consist of a female thread, where a portion of the shaft would feature a male thread. The embodiment shown in FIG. 14 relocates the threaded piston to an external location. It also introduces a method of PRP operation through transmission of the rotation of the shaft.

### Rotary-Linear Transmission

The use of bevel gears and a rack and pinion allows for the rotational movement of the output shaft to be converted to linear movement. This can then be used to operate a pressure relief piston in a similar method to the threaded piston and spring piston concepts. This piston will alter the volume of the core appropriately in order to maintain a constant pressure. FIG. 15 illustrates this concept.

It can be seen from FIG. 15 that as the core cools, the shaft rotates turning the bevel gears, which turns the pinion. The pinion moves the rack, which is coupled to the PRP shaft, thereby causing it to rise. This operation increases the volume of the core in order to accommodate the volumetric change incurred by the expanding SMA wire. The opposite operation occurs during the core's heating cycle where the PRP descends, decreasing the volume of the core. Hence, this mechanism will remove the pressure drop associated with the contracting SMA.

### Mechanical Volume Exchange

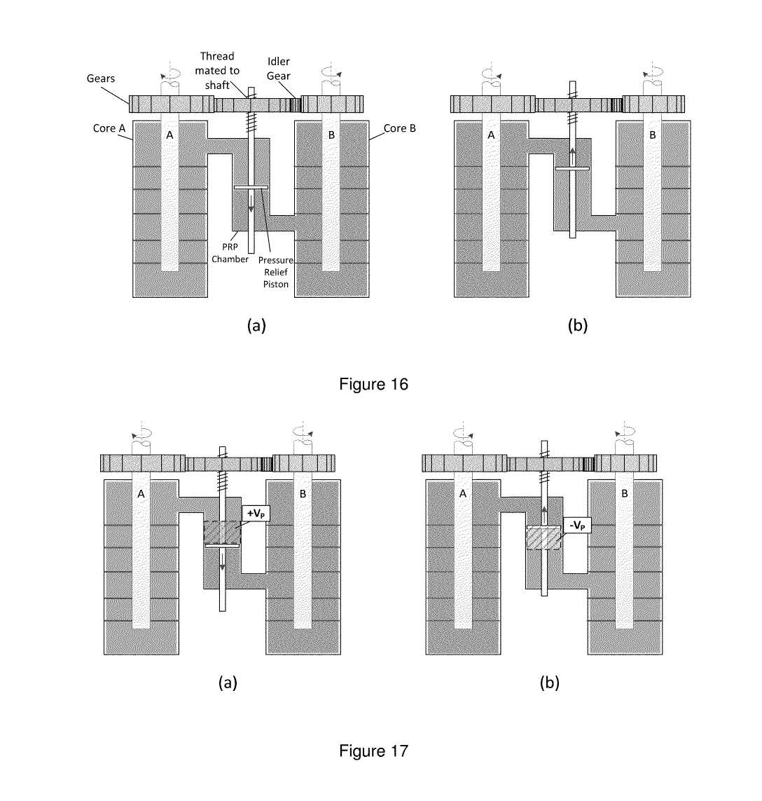

This method of pressure relief can operate by maintaining a constant volume in each core through a piston connection between two cores operating in an antagonistic or opposing fashion. The movement of this piston (or pistons) will be governed by a mechanical linkage between it and the output shafts of the cores. An example of such an arrangement is shown in FIG. 16. In this concept, the force required to operate the PRP will be taken from the power turn of both shafts. The gears attached to either output shaft will then freewheel during its respective core's cooling cycle. The presence of the idler gear is required in order to allow the shafts to rotate the PRP gear in opposite directions.

As can be seen in FIG. 16, as core A heats, its respective SMA components contract. Were the pressure relief mechanism not in place, this would result in an increase in volume. However, this does not occur, as the PRP rises as the SMA contracts, thereby maintaining a constant volume and pressure in this core. This is due to the gear connection, which will cause the PRP to move in a direction which will reduce the volume of core A, while the opposite is true of the PRP in the cooling core B. As the PRP is forced upward by the output shaft in core A, in addition to decreasing the volume of this core, it also increases the volume in core B, thereby offsetting the volumetric decrease caused by the expanding SMA contained therein. This operation is then reversed when the previously cooling core B begins heating, and A begins cooling. The contracting SMA of core B will cause the PRP to descend, due to the gear arrangement present. This will maintain a constant volume in this core as well as core A. The requirement of a central piston rod which runs through the entire PRP chamber is that the piston head must have an equal Cross Sectional Area (CSA) on both sides, as it must displace the same volume on either side during its stroke.

The PRP can displace the correct volume of fluid. This volume will have to be of equal magnitude as that displaced by the SMA contraction. FIG. 17 highlights the volumetric displacements which occur during the operation of this pressure relief device with respect to core A, while the opposite occurs in core B.

As can be seen from FIG. 17, the volumetric displacements which are caused by the SMA wires (V_{SMA}) and the PRP (V_{P}) will cancel each other out if the PRP is sized appropriately. The PRP will be sized correctly if the following relationship is true;

V_{SMA}=V_{P}

Considering this relationship, the following procedure may be followed in order to define a suitable piston size.
1. Using the value of volume displaced by the SMA wire (V_{SMA}), determine the required face surface area of the PRP (A_{P}) to displace this volume, considering the displacement it will undergo is known (x_{M});

$${A}_{P} {x}_{M} = {V}_{SMA}$$

$${A}_{P} = \frac{{V}_{SMA}}{{x}_{M}}$$

2. Determine the required PRP diameter to displace the correct volume, while accounting for the fact that the piston rod which travels the length of the piston head's chamber will not contribute to any volumetric displacements, and hence must be considered in the PRP design. The PRP head must be sized to have a total surface area (A_{T}) which will displace the desired volume in addition to the CSA of the piston rod (A_{R});

$${A}_{T} = {A}_{P} + {A}_{R}$$

$$\frac{π {d}_{T}^{2}}{4} = \frac{{V}_{M}}{{x}_{P}} + \frac{π {d}_{R}^{2}}{4}$$

$${d}_{T} = \sqrt{\frac{4 {V}_{M}}{π {x}_{p}} + {d}_{R}}$$

Where d_{R} is the diameter of the piston rod.

Therefore it can be said that, using the above procedure, it is possible to specify an appropriately sized PRP head based on the SMA volumetric contraction.

The words comprises/comprising when used in this specification are to specify the presence of stated features, integers, steps or components but does not preclude the presence or addition of one or more other features, integers , steps, components or groups thereof.

The invention is not limited to the embodiments hereinbefore described but may be varied in both construction and detail.

1. An energy recovery device comprising:
a first SMA core housed in a first immersion chamber and adapted to be sequentially filled with fluid to allow heating and/or cooling of the first SMA core wherein a first shaft is adapted to be turned by the SMA core mounted concentrically around said first shaft;
a second SMA core housed in a second immersion chamber and adapted to be sequentially filled with fluid to allow heating and/or cooling of the second SMA core wherein a second shaft is adapted to be turned by the second SMA core mounted concentrically around said second shaft;
wherein the first and second core are in fluid communication with each other such that a substantially constant pressure is maintained in the energy recovery device.

2. The energy device of claim 1 wherein the two cores are volumetrically linked and adapted to operate in opposing heating/cooling cycles adapted to allow for volumetric fluctuations to cancel each other out.

3. The energy recovery device of claim 1 wherein the first and second cores are in fluid communication via an adjoining piston or hydraulic line.

4. The energy recovery device of claim 1 wherein a constant volume in each core is maintained through a piston connection between the first and second cores.

5. The energy recovery device of claim 1 wherein the first or second SMA core is linked with a moveable piston in the chamber; wherein the piston is configured with a shaft that has a substantially same Cross Sectional Area (CSA) that will displace the same combined volume of the linear and/or radial contractions of the SMA core over the length of one expansion or contraction.

6. The energy recovery device of claim 1 wherein the first or second SMA core is linked with a moveable first piston in the chamber; and a second piston is adapted to operate in a non-synchronous manner with the first piston.

7. The energy recover device of claim 1 wherein the first or second immersion chamber is configured with an additional chamber comprising a biasing element, such as a spring, wherein on the SMA core expanding in said chamber the biasing element allows fluid to flow into the additional chamber.

8. An energy recovery device comprising:
a first SMA core housed in a first immersion chamber and adapted to be sequentially filled with fluid to allow heating and/or cooling of the first SMA core wherein a first shaft is adapted to be turned by the SMA core mounted concentrically around said first shaft; and
the immersion chamber is configured with an additional chamber comprising a biasing element, such as a spring, wherein on the SMA core expanding in said chamber the biasing element allows fluid to flow into the additional chamber.
